(19) United States
(12) Patent Application Publication
(10) Pub. No.: US 2005/0261904 A1
(43) Pub. Date: Nov. 24, 2005

(54) System and method for voice recognition using user location information

(76) Inventor: Anuraag Agrawal, Bellevue, WA (US)

Correspondence Address: DOCKET CLERK, P.O. BOX 802432, DALLAS, TX, 75380, US

(21) Appl. No.: 10/850,888

(22) Filed: May 20, 2004

(51) Int. Cl. H04M 1/64

(52) U.S. Cl. 704/252

(57) ABSTRACT

An improved voice-recognition system and method that uses location data to build a library of location-specific terms. In one embodiment, the cell site of a caller's wireless telephone is used to determine the approximate geographic location of the user, and based on this location, a list of nearby landmarks is compiled for aide in voice recognition. These landmarks can include street and cross-street names, building names and address ranges, public parks, businesses, and other such landmarks that can easily identify the caller's specific location. Further, based on the determined cell site location, it is not necessary for the user to identify his general location, such as in terms of city and state.

### TECHNICAL FIELD OF THE INVENTION

The present invention is directed, in general, to computer-implemented voice-recognition systems.

### BACKGROUND OF THE INVENTION

Voice recognition systems are well known in the art, as convenient means for entering data into a computer system, whether for purposes of dictation, navigating a “voicemail” system, or otherwise. These systems operate by receiving a voice input and processing the voice input to determine its text equivalent. This process is complicated by the fact that many words are mispronounced, mumbled, or have homonyms, and so determining the intended word from a voice input is a complex task.

The process can be eased, and reliability improved, when the number of possible or likely responses is limited. When this is the case, the voice recognition system can more easily use a “best guess” process to match the voice input with one of the acceptable responses. This sort of process is used, for example, in many telephone-based voice recognition systems, where the system has requested a telephone, credit card, or flight number, and so the only acceptable responses are words that indicate numbers. By comparing the voice input to a list of possible numeric inputs, the system can then determine which of the acceptable responses most closely matches the processed voice input.

One increasingly important use of voice-recognition systems is in mobile telephones, particularly when these phones are used while the user is also driving a car. In these cases, the very act of entering information into a mobile phone using the keypad can be distracting and dangerous, drawing the driver's attention from the road. In this setting in particular, it is very important to have an accurate, effective, and easy to use voice-recognition system.

There is, therefore, a need in the art for a system, method, and computer program product for an improved voice-recognition system.

### SUMMARY OF THE INVENTION

The present invention overcomes the limitations of the prior art and provides additional benefits. A brief summary of some embodiments and aspects of the invention are first presented. Some simplifications and omissions may be made in the following summary. The summary is intended to highlight and introduce some aspects of the disclosed embodiments, but not to limit the scope of the invention. The summary does not provide an exhaustive list of embodiments of the invention.

A detailed description of illustrated embodiments is presented after the summary. The detailed description will permit one skilled in the relevant art to make and use aspects of the invention. One skilled in the relevant art can obtain a full appreciation of aspects of the invention from the subsequent detailed description, read together with the Figures, and from the claims (which follow the detailed description).

A preferred embodiment provides an improved voice-recognition system and method that uses location data to build a library of location-specific terms. In one embodiment, the cell site of a caller's wireless telephone is used to determine the approximate geographic location of the user, and based on this location, a list of nearby landmarks is compiled for aide in voice recognition. These landmarks can include street and cross-street names, building names and address ranges, public parks, businesses, and other such landmarks that can easily identify the caller's specific location. Further, based on the determined cell site location, it is not necessary for the user to identify his general location, such as in terms of city and state.

The foregoing has outlined rather broadly the features and technical advantages of the present invention so that those skilled in the art may better understand the detailed description of the invention that follows. Additional features and advantages of the invention will be described hereinafter that form the subject of the claims of the invention. Those skilled in the art will appreciate that they may readily use the conception and the specific embodiment disclosed as a basis for modifying or designing other structures for carrying out the same purposes of the present invention. Those skilled in the art will also realize that such equivalent constructions do not depart from the spirit and scope of the invention in its broadest form.

Before undertaking the DETAILED DESCRIPTION OF THE INVENTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 depicts a block diagram of an exemplary system in accordance with a preferred embodiment;

FIG. 2 depicts a flowchart of a process in accordance with a preferred embodiment;

FIG. 3 depicts a simple sample inventory in accordance with a preferred embodiment; and

FIG. 4 depicts a simplified diagram of a network system in which various embodiments of the claimed invention can be implemented.

In the drawings, the same reference numbers and acronyms identify elements or acts with the same or similar functionality for ease of understanding and convenience. To easily identify the discussion of any particular element or act, the most significant digit or digits in a reference number refer to the Figure number in which that element is first introduced (e.g., element 1104 is first introduced and discussed with respect to FIG. 11).

Figure numbers followed by the letters “A,” “B,” “C,” etc. indicate either (1) that two or more Figures together form a complete Figure (e.g., FIGS. 10A and 10B together form a single, complete FIG. 10), but are split between two or more Figures because of paper size restrictions, amount of viewable area within a computer screen window, etc., or (2) that two or more Figures represent alternative embodiments or methods under aspects of the invention.

### DETAILED DESCRIPTION OF THE INVENTION

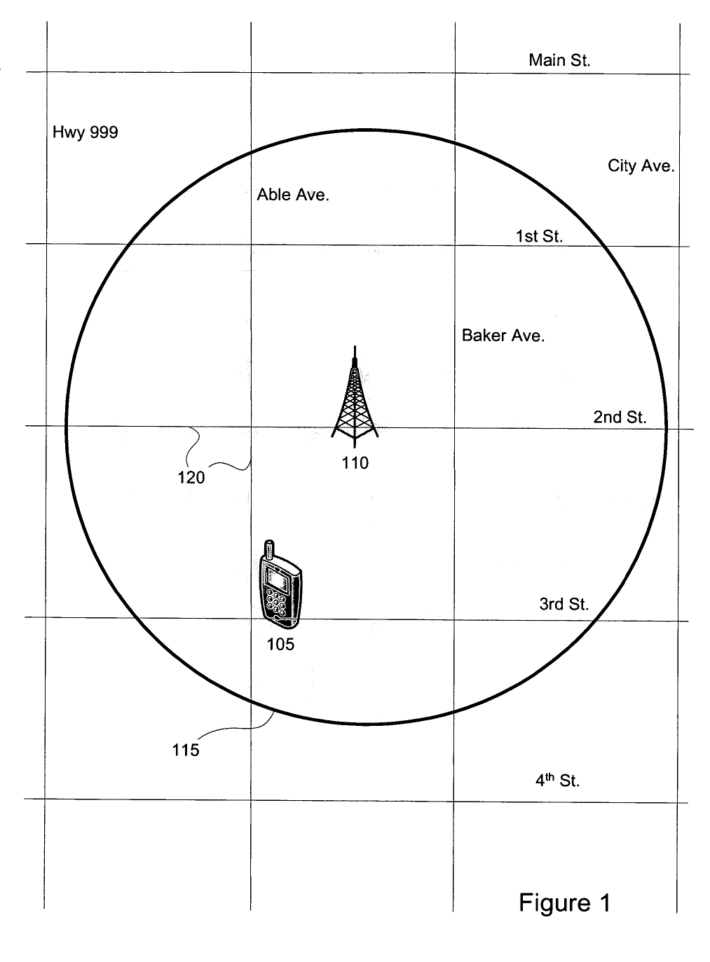

FIGS. 1 through 4, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged device. The numerous innovative teachings of the present application will be described with particular reference to the presently preferred embodiment.

The invention will now be described with respect to various embodiments. The following description provides specific details for a thorough understanding of, and enabling description for, these embodiments of the invention. However, one skilled in the art will understand that the invention may be practiced without these details. In other instances, well known structures and functions have not been shown or described in detail to avoid unnecessarily obscuring the description of the embodiments of the invention.

Definitions: In general, brief definitions of several terms used herein are preceded by the term being enclosed within double quotation marks. Such definitions, although brief, will help those skilled in the relevant art to more fully appreciate aspects of the invention based on the detailed description provided herein. Such definitions are further defined by the description of the invention as a whole (including the claims) and not simply by such definitions.

Systems and techniques for locating a use of a mobile telephone, mobile handset, or other similar wireless device are known in the art. A basic and very well known in the art technique for doing so is imply to identify the cell site or base station that is communicating with the wireless device, and thereby determine that the wireless device is within the signal range of that base station. More sophisticated techniques for locating a wireless device are described in U.S. Pat. Nos. 6,167,274 and 6,580,914, both assigned to AT&T Wireless Services, Inc., and references cited therein, all of which are hereby incorporated by reference.

A preferred embodiment provides an improved voice-recognition system and method that uses location data to build a library of location-specific terms. In one embodiment, the cell site of a caller's wireless telephone is used to determine the approximate geographic location of the user, and based on this location, a list of nearby landmarks is compiled for aide in voice recognition. These landmarks can include street and cross-street names, building names and address ranges, public parks, businesses, and other such landmarks that can easily identify the caller's specific location. Further, based on the determined cell site location, it is not necessary for the user to identify his general location, such as in terms of city and state.

In one preferred embodiment, the voice-recognition system is used in a system for providing directions to a user of a wireless telephone. In this case, when the user calls for directions, the cell site location and voice recognition system is used to efficiently locate the user's starting point for the directions, while reducing the amount of input the user must make to receive the directions.

FIG. 1 depicts a simplified diagram, not to scale, of a wireless device 105 communicating with a base station 110. Also shown is base station operating range 115, and streets 120 within the operating range 115 of base station 110.

Those of skill in the art will recognize that while the operating range 115 of base station 110 is shown here, for the sake of clarity, as a uniform circle, in practice the operating range will vary in each direction according to terrain, obstacles, and other variables. Further, it is will known that in practice, other wireless coverage will abut and overlap the operating range 115 of base station 110.

In this figure, for purposes of the discussion below, the streets 120 have each been named: 1^{st}, 2^{nd}, and 3^{rd} Streets, and Able and Baker Avenues.

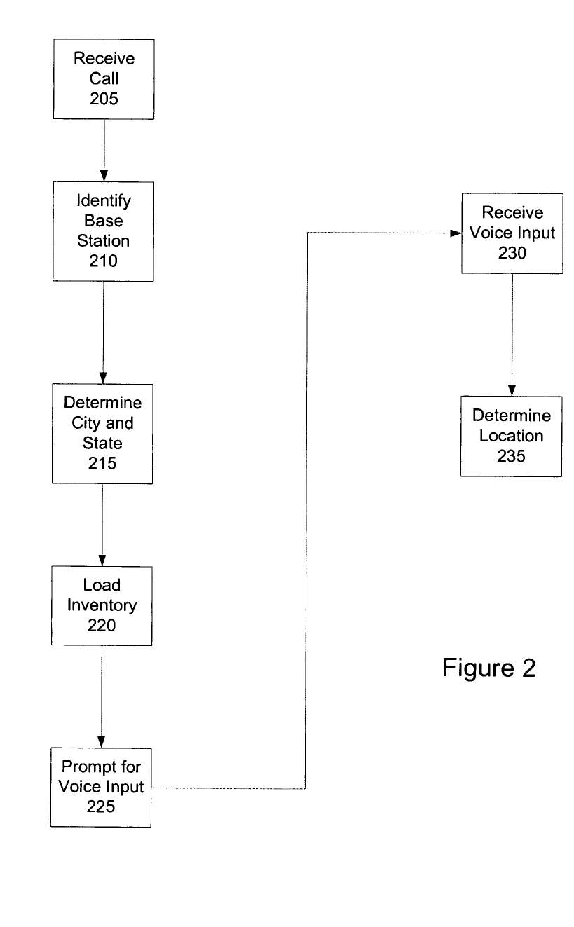

FIG. 2 depicts a flowchart of a process in accordance with a preferred embodiment. In the description below, the term “system” refers to the overall call management and service system of the wireless services provider, but those of skill in the art will recognize that these functions can be performed by third-party service management systems, where cell-site location information is provided to the third-party system by the wireless services provider.

First, the system receives a call from a wireless device (step 205), from a user wishing to know directions, traffic information, or other information that requires the location of the user.

The system will receive data identifying the cell-site or base station serving the wireless device (step 210), and will determine the city and state that is within operating range of that base station (step 215). For simplicity, the city and state in which the cell site is physically located can be used instead of examining its operating range.

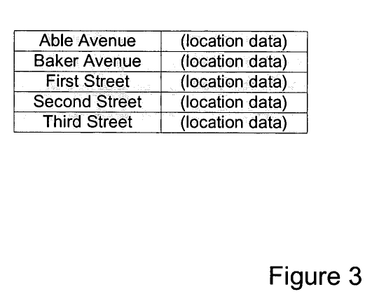

The system will load, from a database, an inventory of landmarks corresponding to the operating range of the cell site (step 220). A simple sample inventory is shown in FIG. 3, including the street names of the exemplary streets shown in FIG. 1. In practice, the inventory can include street names, street address ranges, building names, public parks, businesses, and other such landmarks that can easily identify the caller's specific location. Thos of skill in the art recognize that many systems are available to provide the ability to provide such landmark names within a given radius of a specific address or geographic coordinate. Preferably, the input will include by default such common words used for identifying locations, such as “at”, “corner”, and “and.” Each landmark in the inventory will be associated with a specific location or address.

Of course, there will be numerous landmarks, streets, etc., outside of the operating range of the cell site. In the preferred embodiment, only landmarks within the operating range are included in the inventory, making the inventory relatively small and quick to generate. In this way, there are a limited number of landmark names that have to be matched to the voice input.

The inventory can alternately be created on-the-fly as the base station is identified, rather than being loaded from a database.

The system will prompt the user for a voice input to specifically identify the user's current location (step 225). The system will then receive a voice input (step 230), such as “Third Street at Able Avenue,” as wireless device 105 is shown in FIG. 1.

The voice input is then compared, using known voice-recognition techniques, to the inventory to determine the landmarks identified by the user (step 230). Because the inventory is preferably limited to landmarks within the operating range of the base station, the voice recognition system can be much more efficient and accurate, since there are a limited number of potential inputs.

Once the landmarks have been identified, the system determines the actual location of the user within the operating range (step 235), with reasonable accuracy. This is done by determining the associated locations of the identified landmarks, along with any specified addresses or intersections. In this example, the system will determine the location range of Third Street, and compare it with the location range of Able Avenue, and thereby determine the specific location of the intersection of those streets. Techniques for determining a geographic location based on street intersections is well known to those of skill in the art.

Having determined the location of the wireless device and user, the system can then proceed to process the remainder of the service the user was requesting. Preferably, the user is never required to enter the city and state in which he is located, as this is determined either from the base station location or, when the operating range of the base station includes more than one city or state, from the specific location as determined from the inventory, as described above.

Those of skill in the art recognize that the steps in the process described above are not necessarily performed in the order described. Further, while a preferred embodiment herein is specifically applicable to users using a mobile telephone or other wireless device, similar inventory-list and voice-recognition techniques can be used for wired or land-line telephones and devices. In this case, instead of using the base station location to determine an initial operating range, the system can use the caller's area code and telephone number to determine the caller's immediate area, and then build an inventory list from landmarks proximal to the caller, such as within a specified radius.

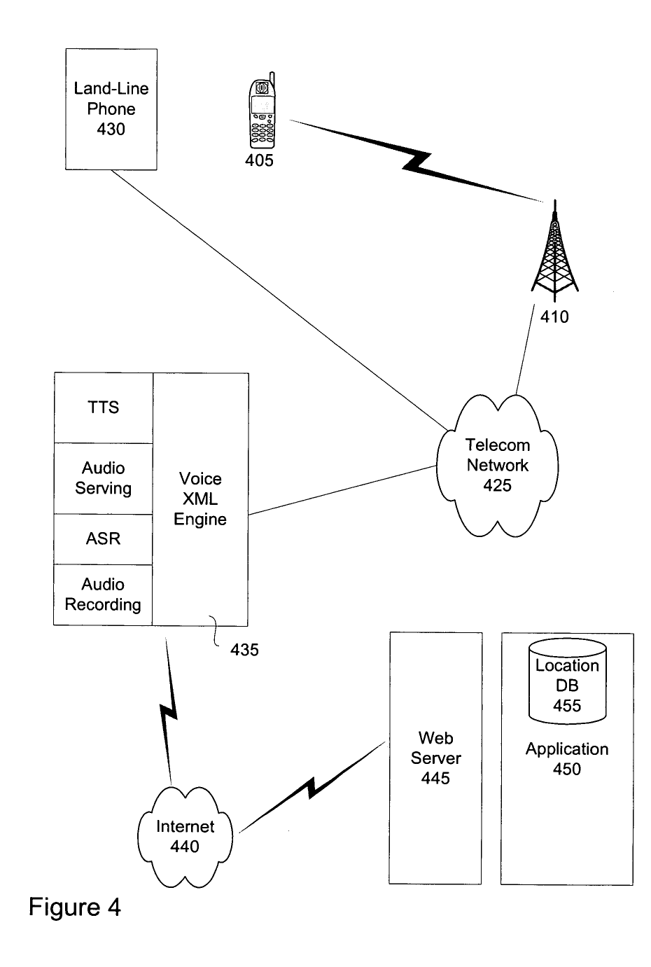

FIG. 4 depicts a simplified diagram of a network system in which various embodiments of the claimed invention can be implemented. Here, telecom network 425 is shown, which is preferably a wireless/wireline telecommunications network, communicating with land-line phone 430 and base station 410. Base station 410 communicates with wireless device 405, which is preferably a mobile telephone. For purposes of clarity, other conventional parts of telecommunications network 425 are not shown, as they are well known to those of skill in the art and not essential to understanding the claimed invention.

The telecommunications network 425 communicates with voice browser system 435, which can be implemented using voice browser/voicemail systems known to those In the preferred embodiment, voice browser system 435 includes components such as a VoiceXML engine, audio serving and audio recording subsystems, Text-to-Speech (TTS) engine, and an automatic speech recognition (ASR) subsystem. The voice browser system 435 will convert the voice input into VoiceXML for communication over internet 440. In practice, network 440 can be the internet or any other public or private data network.

Web server 445 receives the VoiceXML communications from voice browser 435, and accesses application 450. Application 450 includes location database 455, as described above. Application 450 responds to webserver 445 over internet 440.

One embodiment of the present invention includes a method for voice recognition, comprising receiving a communication request from a calling device; determining the location, within a first geographic area, of the calling device; loading a list of geographic landmarks corresponding to the first geographic area, each geographic landmark having associated location data; receiving a voice input from the calling device; comparing the voice input to the list of geographic landmarks; and determining the location, within a second geographic area smaller than the first geographic area, of the calling device based on the voice input.

It is important to note that while the present invention has been described in the context of a fully functional system, those skilled in the art will appreciate that at least portions of the mechanism of the present invention are capable of being distributed in the form of a instructions contained within a machine usable medium in any of a variety of forms, and that the present invention applies equally regardless of the particular type of instruction or signal bearing medium utilized to actually carry out the distribution. Examples of machine usable mediums include: nonvolatile, hard-coded type mediums such as read only memories (ROMs) or erasable, electrically programmable read only memories (EEPROMs), user-recordable type mediums such as floppy disks, hard disk drives and compact disk read only memories (CD-ROMs) or digital versatile disks (DVDs), and transmission type mediums such as digital and analog communication links. Aspects of the invention described above may be stored or distributed on computer-readable media, including magnetic and optically readable and, removable computer discs, as well as distributed electronically over the Internet or over other networks (including wireless networks). Those skilled in the relevant art will recognize that portions or embodiments of the invention may reside in a fixed element of a communication network, while corresponding portions may reside on a mobile communication device. Data structures and transmission of data particular to aspects of the invention are also encompassed within the scope of the invention.

Although an exemplary embodiment of the present invention has been described in detail, those skilled in the art will understand that various changes, substitutions, variations, and improvements of the invention disclosed herein may be made without departing from the spirit and scope of the invention in its broadest form. Although embodiments of the invention have been described primarily in the context of wireless networks, the teachings of the invention provided herein can be applied to many other types of networks and network operators. Embodiments of the invention could be applied to any sort of network where the network operator must off-load some traffic onto another operator's network. For example, those skilled in the art could apply the teachings of the invention to an Internet Service Provider (ISP) network. Although embodiments of the invention are described with a VOIP network, those skilled in the art understand that many equivalent packet schemes are suitable, such as Voice over Frame Relay (VoFR), Voice over Asynchronous Transfer Mode (VoATM), Voice over Cable (VoC), Voice and Fax over Internet Protocol (V/FoIP), or Voice over Digital Subscriber Line (VODSL). These and other changes can be made to the invention in light of the detailed description.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC §112 unless the exact words “means for” are followed by a participle.

1. A method for voice recognition, comprising:
receiving a communication request from a calling device;
determining the location, within a first geographic area, of the calling device;
loading a list of geographic landmarks corresponding to the first geographic area, each geographic landmark having associated location data;
receiving a voice input from the calling device;
comparing the voice input to the list of geographic landmarks; and
determining the location, within a second geographic area smaller than the first geographic area, of the calling device based on the voice input.

2. The method of claim 1, wherein the first geographic area is the operating range of a wireless network base station.

3. The method of claim 1, wherein the geographic landmarks include street names.

4. The method of claim 1, wherein the second geographic area is a street intersection.

5. The method of claim 1, wherein the calling device is a wireless telephone.

6. The method of claim 1, wherein the voice input does not include the identification of a city or state.

7. The method of claim 1, further comprising identifying a wireless network base station in communication with the calling device.

8. A method for voice recognition, comprising:
receiving a communication request from a wireless device;
identifying a base station in communication with the wireless device;
determining the location of the base station;
loading a list of geographic landmarks within in an operating range of the base station;
receiving a voice input from the calling device;
comparing the voice input to the list of geographic landmarks; and
determining the location, within the operating range of the base station, of the calling device based on the voice input.

9. The method of claim 8, wherein the geographic landmarks include street names.

10. The method of claim 8, wherein the calling device is a wireless telephone.

11. The method of claim 8, wherein the voice input does not include the identification of a city or state.

12. The method of claim 8, further comprising determining the city and state location of the wireless device based on the location of the base station.

13. A telecommunication network system, comprising:
means for receiving a communication request from a wireless device;
means for identifying a base station in communication with the wireless device;
means for determining the location of the base station;
means for loading a list of geographic landmarks within in an operating range of the base station;
means for receiving a voice input from the calling device;
means for comparing the voice input to the list of geographic landmarks; and
means for determining the location, within the operating range of the base station, of the calling device based on the voice input.

14. The system of claim 13, wherein the geographic landmarks include street names.

15. The system of claim 13, wherein the calling device is a wireless telephone.

16. The system of claim 13, wherein the voice input does not include the identification of a city or state.

17. A computer program product tangibly embodied in a machine-readable medium, comprising:
instructions for receiving a communication request from a wireless device;
instructions for identifying a base station in communication with the wireless device;
instructions for determining the location of the base station;
instructions for loading a list of geographic landmarks within in an operating range of the base station;
instructions for receiving a voice input from the calling device;
instructions for comparing the voice input to the list of geographic landmarks; and
instructions for determining the location, within the operating range of the base station, of the calling device based on the voice input.

18. The computer program product of claim 17, wherein the geographic landmarks include street names.

19. The computer program product of claim 17, wherein the calling device is a wireless telephone.

20. The computer program product of claim 17, wherein the voice input does not include the identification of a city or state.

21. The computer program product of claim 17, further comprising instructions for determining the city and state location of the wireless device based on the location of the base station.
